(19) United States
(12) Patent Application Publication
(10) Pub. No.: US 2008/0027819 A1
(43) Pub. Date: Jan. 31, 2008

(54) Methods, systems, and products for purchasing products

(76) Inventors: John Ruckart, Atlanta, GA (US); Samuel N. Zellner, Dunwoody, GA (US)

Correspondence Address: SCOTT P. ZIMMERMAN, PLLC, PO BOX 3822, CARY, NC, 27519, US

(21) Appl. No.: 11/495,925

(22) Filed: Jul. 29, 2006

(51) Int. Cl. G06Q 30/00

(52) U.S. Cl. 705/26

(57) ABSTRACT

Methods, systems, and products are disclosed for purchasing products. A purchase request to purchase an electronic copy of a product is received. The purchase request includes a product number that uniquely identifies the product and a device number that uniquely identifies a requesting device. The product number and the device number are communicated for registration. A verification is received that the product number and the device number have been successfully registered. The electronic copy of the product is communicated to the requesting device.

### NOTICE OF COPYRIGHT PROTECTION

A portion of this disclosure and its figures contain material subject to copyright protection. The copyright owner has no objection to the facsimile reproduction by anyone of the patent document or the patent disclosure, but otherwise reserves all copyrights whatsoever.

### BACKGROUND

This application generally relates to data processing and, more particularly, to electronic shopping.

The purchase of electronic products is wasteful and challenging. When consumers purchase electronic products (such as computer software) from retail stores, the electronic product is unnecessarily packaged. Computer software, for example, is packaged in a paper or plastic container and then shrink-wrapped in plastic. An anti-theft device is sometimes added to the packaging. The purchasing consumer opens the package, removes the software, and then throws away the packaging and the anti-theft device. The purchasing customer then attempts to install the software, with varying degrees of success. The product packaging thus provides little, if any, value to the customer. Moreover, retail merchants struggle with product packaging that unnecessarily consumes valuable shelf space. What is needed, then, are methods, systems, and products that provide for the purchase of electronic products while reducing wasteful product packaging, reducing shelf space, and reducing the complexity of product activation.

### SUMMARY

The aforementioned problems, and other problems, are reduced, according to exemplary embodiments, using methods, systems, and products that automate the purchase and transfer process for electronic, or “virtual,” products. When a customer desires to purchase software, games, ringtones, or any other electronic product, exemplary embodiments permit that purchase without requiring that electronic product to be physically packaged. The purchasing customer selects their desired product by scanning a bar code label, receiving an RFID signal, or otherwise indicating the desired software product. The purchasing customer's communications device is also uniquely identified. Exemplary embodiments then register the customer's communications device with the electronic product desired for purchase. Once the customer's communications device is registered, a licensed electronic copy of the desired product is transferred or “pushed” to the customer's communications device. Because the electronic copy is automatically registered prior to download, instances of intellectual property theft may be reduced. Moreover, exemplary embodiments reduce, or even eliminate, wasteful product packaging, wrappings, and even paper manuals. Exemplary embodiments also improve customer experience by automatically downloading, installing and registering the electronic product.

The exemplary embodiments describe a method for purchasing products. A purchase request to purchase an electronic copy of a product is received. The purchase request includes a product number that uniquely identifies the product and a device number that uniquely identifies a requesting device. The product number and the device number are communicated for registration. A verification is received that the product number and the device number have been successfully registered. The electronic copy of the product is communicated to the requesting device.

In another of the embodiments, a system is disclosed for purchasing products. A commerce application is stored in memory, and a processor communicates with the memory. The processor receives a purchase request to purchase an electronic copy of a product. The purchase request comprises a product number that uniquely identifies the product and a device number that uniquely identifies a requesting device. The processor communicates the product number and the device number for registration and receives a verification message that the product number and the device number have been successfully registered. The processor communicates the electronic copy of the product to the requesting device.

In yet another embodiment, a computer program product is also disclosed for purchasing products. The computer program product stores computer code for receiving a purchase request to purchase an electronic copy of a product. The purchase request comprises a product number that uniquely identifies the product and a device number that uniquely identifies a requesting device. The product number and the device number are communicated for registration. A verification is received that the product number and the device number have been successfully registered. The electronic copy of the product is communicated to the requesting device.

Other systems, methods, and/or computer program products according to the exemplary embodiments will be or become apparent to one with ordinary skill in the art upon review of the following drawings and detailed description. It is intended that all such additional systems, methods, and/or computer program products be included within this description, be within the scope of the claims, and be protected by the accompanying claims.

### BRIEF DESCRIPTION OF THE SEVERAL VIEWS OF THE DRAWINGS

These and other features, aspects, and advantages of the exemplary embodiments are better understood when the following Detailed Description is read with reference to the accompanying drawings, wherein:

FIG. 1 is a simplified schematic illustrating a network environment in which exemplary embodiments may be implemented;

FIG. 2 is a schematic illustrating additional enhancements for purchasing electronic products, according to more exemplary embodiments;

FIG. 3 is a schematic illustrating proxy information for purchasing electronic products, according to even more exemplary embodiments;

FIGS. 4 and 5 are schematics illustrating a process for purchasing products, according to still more exemplary embodiments;

FIG. 6 is a schematic illustrating another process for purchasing products, according to more exemplary embodiments;

FIG. 7 depicts other possible operating environments, according to more exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (ie., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

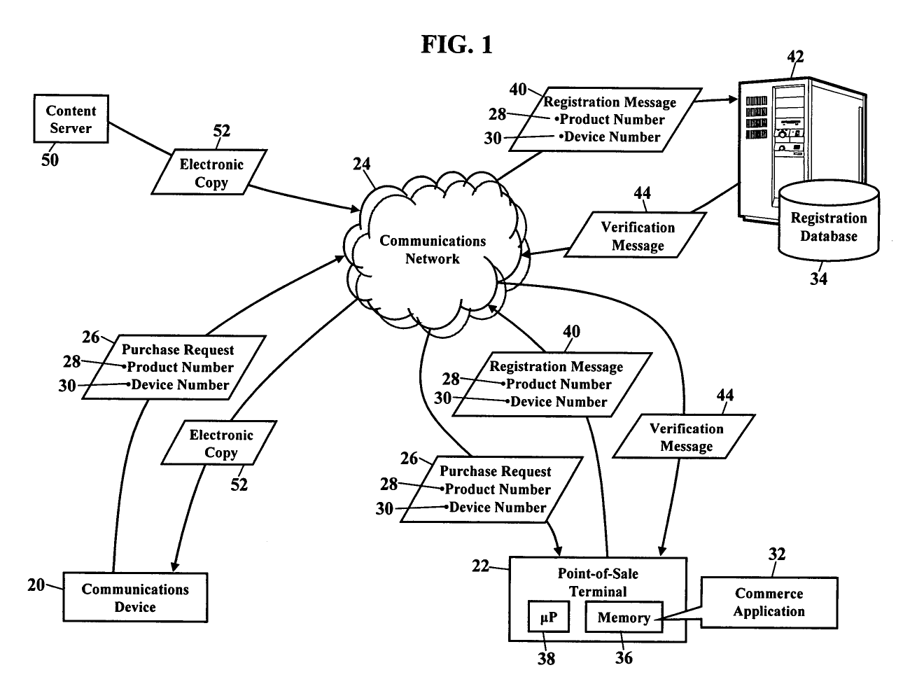

FIG. 1 is a simplified schematic illustrating a network environment in which exemplary embodiments may be implemented. A user's communications device 20 communicates with a point-of-sale terminal 22 via a communications network 24. Although the user's communications device 20 is generically shown, the communications device 20, as will be later explained, may be any computer, personal digital assistant, cordless/cellular/IP phone, or any other processor-controlled device. Also, although only one communications device 20 is shown, it should be appreciated that there may be any number of communication devices 20. Whatever the user's communications device 20, the user's communications device 20 communicates a purchase request 26 to the point-of-sale terminal 22. The purchase request 26 describes an electronic copy of a product for which the user wishes to purchase. The purchase request 26, for example, may describe music, movie(s), picture(s), software, ringtone(s), game(s), electronic book, or any other electronic product or content. The purchase request 26 includes a product number 28 and a device number 30. The product number 28 may be a SKU number, a bar code number, an RFID tag/label number, or any other alphanumeric identifier or code that uniquely identifies the product to be purchased. The device number 30 is any alphanumeric identifier or code that uniquely identifies the user's requesting communications device 20.

The point-of-sale terminal 22 receives the purchase request 26. A commerce application 32 then initiates communication with a registration database 34. The commerce application 32 is a set of processor-executable instructions that are stored in memory 36 of the point-of-sale terminal 22. The commerce application 32 is a software engine that instructs a processor 38 to send a registration message 40 to the registration database 34. The registration message 40 includes the product number 28 and the device number 30.

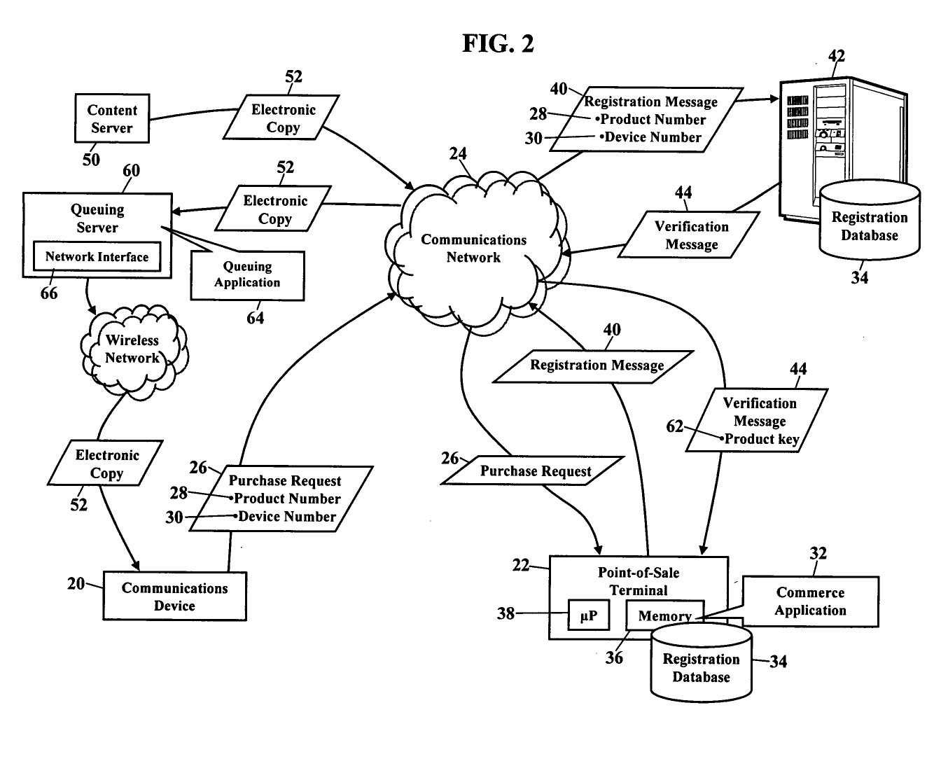

The registration database 34 receives the registration message 40 and performs a registration. The registration database 34 is stored in the memory of a registration server 42 (although the registration database 34 may be locally stored in the point-of-sale terminal 22, as shown in FIG. 2). The registration database 34 associates the product number 28 with the device number 30. The registration database 34 thus registers the user's communications device 20 as a licensed user of the purchased product (e.g., music, movie, software, or any other electronic content). The registration database 34 thus maintains a listing of devices that store authorized copies of electronic products. When the registration database 34 associates the product number 28 with the device number 30, the registration database 34 sends a verification message 44. The verification message 44 verifies that the product number 28 and the device number 30 have been successfully registered in the registration database 34.

The point-of-sale terminal 22 receives the verification message 44. The commerce application 32 may inspect the verification message 44 to ensure registration was successful. If registration is successful, the commerce application 32 approves a download of the purchased electronic product to the user's communications device 20. If registration was unsuccessful, the commerce application 32 may attempt to send a second, redundant registration message 40, or the commerce application 32 may cancel the user's purchase request 26.

The electronic product is communicated to the user's communications device 20. When the registration is successful, the commerce application 32 may be authorized to download, transfer, or otherwise communicate an electronic copy of the purchased product to the requesting user's communications device 20. The point-of-sale terminal 22, for example, may communicate with a content server 50 (via the communications network 24), request and receive an electronic copy 52 of the purchased product, and wirelessly or wiredly communicate that electronic copy 52 to the user's communications device 20. The point-of-sale terminal 22 may wirelessly communicate the electronic copy 52 using any portion of the electromagnetic spectrum and any signaling standard (such as the IEEE 802 family of standards, GSM/CDMA/TDMA or any cellular standard, and/or the ISM band). The point-of-sale terminal 22 may additionally or alternatively communicate the electronic copy 52 using a wired connection (e.g., USB or IEEE 1394 “FIREWIRE®”) (FIREWIRE® is a registered trademark of Apple Computer, Inc.). The point-of-sale terminal 22 may additionally or alternatively prepare a removable media storage device (such as disk, DC/DVD, compact flash, or other RAM) for physical transfer. The point-of-sale terminal 22 may alternatively instruct the content server 50 to send the electronic copy 52 of the purchased product to the user's communications device 20.

Exemplary embodiments thus automate the purchase and transfer process for virtual products. Once the user's electronic device 20 is registered in the registration database 34, the licensed electronic copy 52 is “pushed” to the user's electronic device 20. Exemplary embodiments reduce, or even eliminate, human errors when entering the product number 28 and the device number 30. Because the electronic copy 52 is automatically registered prior to download, instances of intellectual property theft may be reduced. Moreover, exemplary embodiments are environmentally friendly by reducing, or even eliminating, wasteful product packaging, wrappings, and paper manuals. Exemplary embodiments also improve customer experience by automatically downloading, installing and registering the electronic product.

Exemplary embodiments may be applied regardless of networking environment. The user's communications device 20 and the point-of-sale terminal 22 may operate using wired or wireless principles. The communications network 24 may be a cable network operating in the radio-frequency domain and/or the Internet Protocol (IP) domain. The communications network 24 may have POTS components and/or features. The communications network 24, however, may also include a distributed computing network, such as the Internet (sometimes alternatively known as the “World Wide Web”), an intranet, a local-area network (LAN), and/or a wide-area network (WAN). The communications network 24 may include coaxial cables, copper wires, fiber optic lines, and/or hybrid-coaxial lines. The communications network 24 may even include wireless portions utilizing any portion of the electromagnetic spectrum and any signaling standard (such as the I.E.E.E. 802 family of standards, GSM/CDMA/TDMA or any cellular standard, and/or the ISM band). The concepts described herein may be applied to any wireless/wireline communications network or communications device, regardless of physical componentry, physical configuration, or communications standard(s).

The user's communications device 20, the point-of-sale terminal 22, the registration server 42, and the content server 50 are only simply illustrated. Because the architecture and operating principles of computers, communications devices, and other processor-controlled devices are well known, the hardware and software components are not further shown and described. If, however, the reader desires more details, the reader is invited to consult the following sources, all incorporated herein by reference in their entirety: ANDREW TANENBAUM, COMPUTER NETWORKS (4^{th} edition 2003); WILLIAM STALLINGS, COMPUTER ORGANIZATION AND ARCHITECTURE: DESIGNING FOR PERFORMANCE (7^{th} Ed., 2005); and DAVID A. PATTERSON & JOHN L. HENNESSY, COMPUTER ORGANIZATION AND DESIGN: THE HARDWARE/SOFTWARE INTERFACE (3^{rd}. Edition 2004).

Additionally, some aspects of electronic shopping are known, so this disclosure does not greatly explain the known details. If the reader desires more details, the reader is invited to consult the following sources, all incorporated herein by reference in their entirety: U.S. Pat. No. 5,572,442 to Schulhof et al.; U.S. Pat. No. 6,457,640 to Ramachandran et al.; U.S. Pat. No. 6,823,172 to Forrest; U.S. Pat. No. 6,840,444 to Pierce et al.; U.S. Pat. No. 6,959,285 to Stefanik et al.; U.S. Pat. No. 6,973,476 to Naden et al.; Published U.S. Patent Application 2001/0013120 to Tsukamoto; Published U.S. Patent Application Ser. No. 2001/0037360 to Ekkel; Published U.S. patent application Ser. No. 2003/0033243 to Baker et al.; Published U.S. Patent Application Ser. No. 2004/0002359 to Deas et al.; Published U.S. Patent Application Ser. No. 2004/0054597 to Gulliver et al.; and Published U.S. Patent Application Ser. No. 2004/0230489 to Goldthwaite et al.

FIG. 2 is a schematic illustrating additional enhancements for purchasing electronic products, according to more exemplary embodiments. Here a queuing server 60 is used to deliver the electronic copy 52 to the user's communications device 20. The user's communications device 20, as before, communicates the purchase request 26 to the point-of-sale terminal 22. The purchase request 26 describes an electronic copy of a product for which the user wishes to purchase. The commerce application 32 instructs the processor 38 to send the registration message 40 to the registration database 34. The registration database 34 may be locally stored in the memory 36 of the point-of-sale terminal 22, or the registration database 34 may be remotely located (such as in the registration server 42) and accessible via the communications network 24. Regardless, the registration database 34 receives the registration message 40 and associates the product number 28 with the device number 30. The registration database 34 returns the verification message 44 to verify that the product number 28 and the device number 30 have been successfully registered. The point-of-sale terminal 22 then receives the verification message 44, and here the verification message 44 comprises a product key 62. The product key 62 is used to activate the electronic copy 52. The commerce application 32 then authorizes a transfer, download, or communication of the electronic copy 52 to the user's communications device 20. The commerce application 32 also authorizes communication of the product key 62 to the user's communications device 20. The user's communications device 20 then uses the product key 62 to install and activate the electronic copy 52, as is known.

Here the electronic copy 52, however, is delivered from the queuing server 60. When the commerce application 32 authorizes the electronic copy 52 to be sent to the user's communications device 20, the point-of-sale terminal 22 may delegate that operation to the queuing server 60. Because the electronic copy 52 may be a rather large file or stream (such as a movie), some merchants may not want the point-of-sale terminal 22 involved in a time-consuming data transfer. Some merchants, instead, may want the point-of-sale terminal 22 to simply authorize the transfer and then “move on” to another paying customer. The point-of-sale terminal 22, then, may communicate with the content server 50 and instruct the content server 50 to forward the electronic copy 52 of the purchased product to the queuing server 60. When the queuing server 60 receives the electronic copy 52, a queuing application 64 adds the electronic copy 52 to a queue memory. When multiple customers desire authorized downloads of their purchased products, those products are queued for delivery. As electronic products are delivered, the electronic copy 52 advances in the queue. When the electronic copy 52 advances to a first position, the queuing application 64 instructs a network interface 66 to transfer the electronic copy 52 to the user's communications device 20. According to an exemplary embodiment, the network interface 66 wirelessly communicates the electronic copy 52 using any portion of the electromagnetic spectrum and any signaling standard (such as the I.E.E.E. 802 family of standards, GSM/CDMA/TDMA or any cellular standard, and/or the ISM band). The network interface 66, however, may additionally or alternatively communicate the electronic copy 52 using a wired connection (e.g., USB or IEEE 1394 “FIREWIRE®”) (FIREWIRE® is a registered trademark of Apple Computer, Inc.). The queuing application 64 and/or the commerce application 32 may additionally or alternatively prepare a removable media storage device (such as disk, compact flash, or other RAM) for physical transfer.

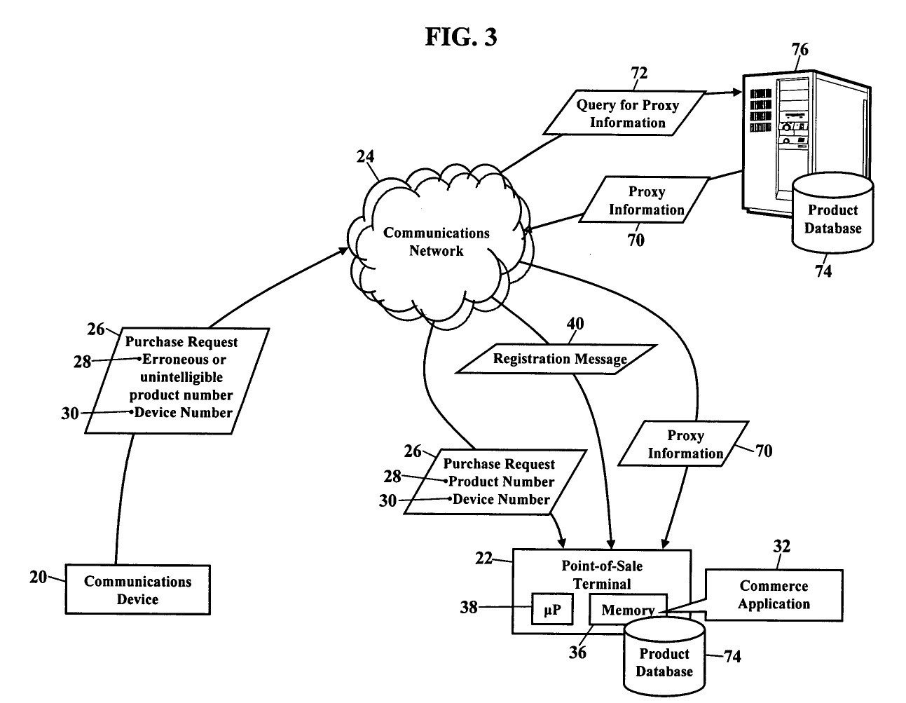

FIG. 3 is a schematic illustrating proxy information for purchasing electronic products, according to even more exemplary embodiments. Here the commerce application 32 receives proxy information 70 that uniquely represents the product for purchase. When the user's communications device 20 communicates the purchase request 26, the purchase request 26 may or may not accurately describe the product for purchase. If, for any reason, the user's communications device 20 fails to send the purchase request 26 that accurately comprises the product number 28, here the commerce application 32 may query for and obtain the product number 28. Because the purchase request 26 originates from the user's communications device 20, the purchase request 26 may be expected to include the device number 30 that uniquely identifies the user's requesting communications device 20. But when the purchase request 26 fails to include an accurate product number 28, the commerce application 32 may take remedial actions.

The commerce application 32 may query for the proxy information 70. The proxy information 70 is any information that helps the commerce application 32 accurately identify the product described in the purchase request 26. The proxy information 70, for example, may be stock keeping unit (or “SKU”) number that describes the desired product. The proxy information 70 may additionally or alternatively include a bar code number that describes the desired product. The proxy information 70 may additionally or alternatively include an RFID tag/label number that describes the desired product. The proxy information 70 may additionally or alternatively include any information included with the purchase request 26 received from the user's communications device 20, such as a product description, manufacturer, color, size, price, or even store location.

Whatever the proxy information 70 may include, the commerce application 32 may query for the proxy information 70. The commerce application 32, for example, may send a query 72 to a product database 74. The product database 74 stores information that describes products available for purchase. The product database 74 may be locally stored in the memory 36 of the point-of-sale terminal 22, or the product database 74 may be remotely stored in a database server 76 and accessible via the communications network 24. Regardless, the commerce application 32 may query the product database 74 to obtain any proxy information 70 that helps uniquely identify the user's desired product for purchase. The product database 74 then sends a response that includes any proxy information 70 matching the search query.

The commerce application 32 may additionally or alternatively query RFID devices. When the user's purchase request 26 fails to include an accurate product number 28, the commerce application 32 may query any radio frequency identification (“RFID”) devices for the proxy information 70. If an RFID device may be queried, the RFID device may respond with any proxy information 70 matching the search query.

The commerce application 32 receives the proxy information 70. The proxy information 70 is any information that helps the commerce application 32 accurately identify the product described in the purchase request 26. Once the proxy information 70 is obtained, the commerce application 32 may then query the product database 74 for the product number 28. The product number 28 uniquely identifies the product described in the user's purchase request 26. Once the product number 28 is obtained, the commerce application 32 instructs the processor 38 to send the registration message 40, as earlier described.

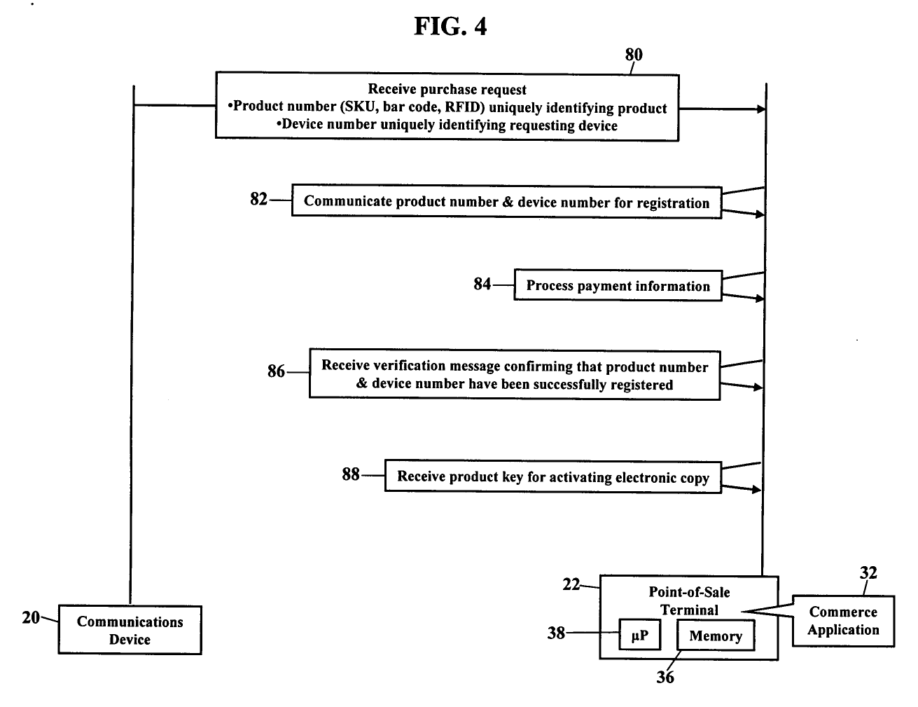

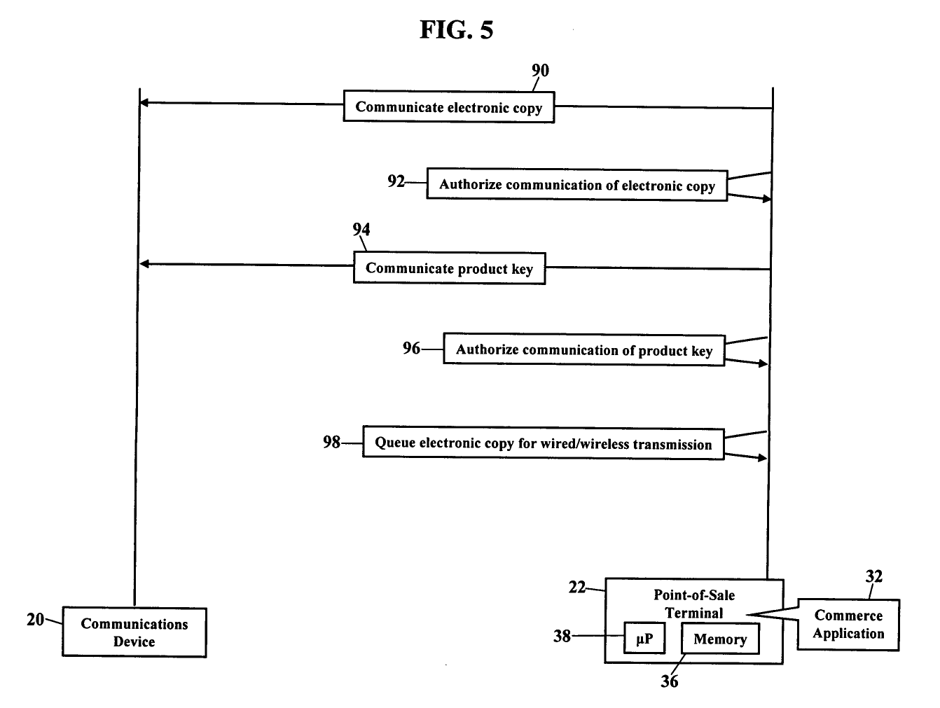

FIGS. 4 and 5 are schematics illustrating a process for purchasing products, according to still more exemplary embodiments. Here the point-of-sale terminal 22 receives the purchase request from the user's communications device 20 (Step 80). The purchase request describes an electronic product that the user wishes to purchase, and the purchase request comprises the product number 28 and the device number 30. The device number 30 may include at least one of a SKU, a bar code, and an RFID that uniquely identifies the product. The point-of-sale terminal 22 communicates the product number and the device number for registration (Step 82). The point-of-sale terminal 22 may also process payment information for the electronic copy (Step 84). A verification message is received and confirms that the product number and the device number have been successfully registered (Step 86). The commerce application 32 may also receive the product key that activates the electronic copy (Step 88).

The process continues with FIG. 5. The commerce application 32 then communicates the electronic copy of the product to the user's communications device 20 (Step 90). The commerce application 32 may alternatively authorize communication of the electronic copy of the product to the user's communications device 20 (Step 92). The commerce application 32 also communicates (Step 94), or authorizes communication of (Step 96), the product key to the requesting user's communications device 20. The electronic copy may be queued for wired/wireless transmission to the requesting user's communications device 20 (Step 98).

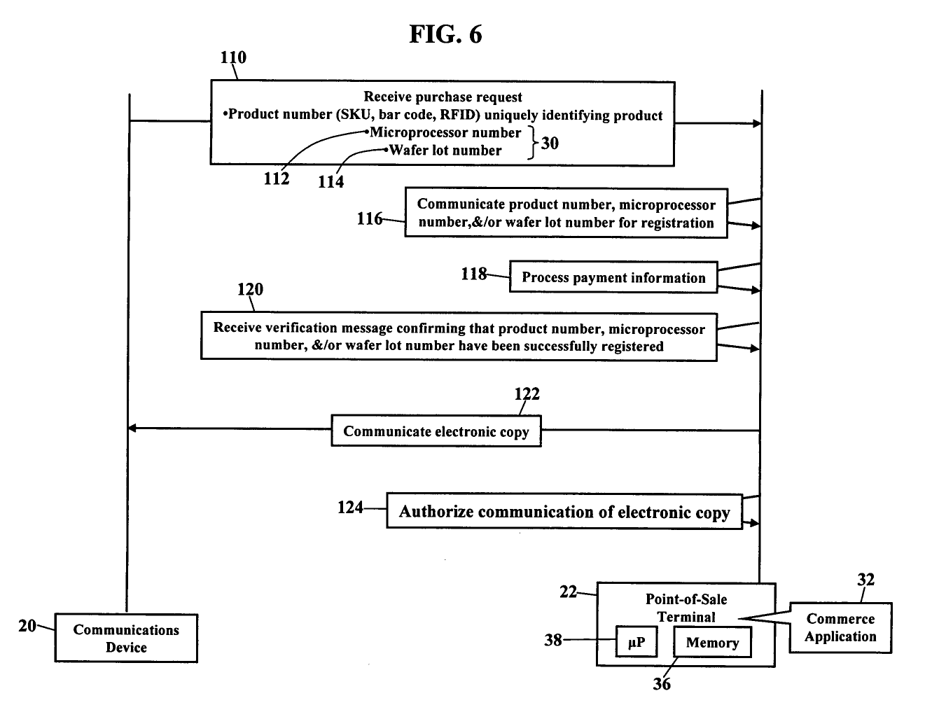

FIG. 6 is a schematic illustrating another process for purchasing products, according to more exemplary embodiments. The point-of-sale terminal 22 receives the purchase request comprising the product number 28 and the device number 30 (Step 110). The device number 30 may include a microprocessor number 112 and/or a wafer lot number 114. The microprocessor number 112 is a serial number and/or die number that uniquely identifies a microprocessor operating in the requesting user's communications device 20. The wafer lot number 114 identifies a wafer lot from which the microprocessor (operating in the requesting user's communications device 20) was manufactured. Either the microprocessor number 112, or the wafer lot number 114, or both may be used to uniquely identify the user's communications device 20. The point-of-sale terminal 22 communicates the microprocessor number 112 and/or the wafer lot number 114 for registration (Step 116). The point-of-sale terminal 22 may also process payment information for the electronic copy (Step 118). A verification message is received and confirms that the product number, the microprocessor number, and/or the wafer lot number have been successfully registered (Step 120). The commerce application 32 then communicates (Step 122), or authorizes communication of (Step 124), the electronic copy of the product to the user's communications device 20.

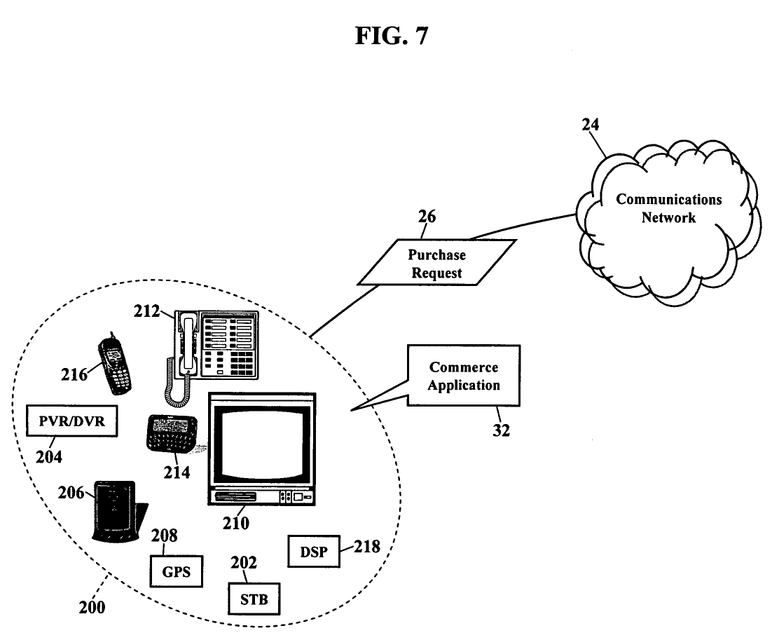

FIG. 7 depicts other possible operating environments, according to more exemplary embodiments. FIG. 7 illustrates that the commerce application 32 may alternatively or additionally operate within various other communications devices 200. FIG. 7, for example, illustrates that the commerce application 32 may entirely or partially operate within a set-top box (202), a personal/digital video recorder (PVR/DVR) 204, personal digital assistant (PDA) 206, a Global Positioning System (GPS) device 208, an interactive television 210, an Internet Protocol (IP) phone 212, a pager 214, a cellular/satellite phone 216, or any computer system and/or communications device utilizing a digital signal processor (DSP) 218. The communications device 200 may also include watches, radios, vehicle electronics, clocks, printers, gateways, and other apparatuses and systems. Because the architecture and operating principles of the various communications devices 200 are well known, the hardware and software componentry of the various communications devices 200 are not further shown and described. If, however, the reader desires more details, the reader is invited to consult the following sources, all incorporated herein by reference in their entirety: LAWRENCE HARTE et al., GSM SUPERPHONES (1999); SIEGMUND REDL et al., GSM AND PERSONAL COMMUNICATIONS HANDBOOK (1998); and JOACHIM TISAL, GSM CELLULAR RADIO TELEPHONY (1997); the GSM Standard 2.17, formally known Subscriber Identity Modules, Functional Characteristics (GSM 02.17 V3.2.0 (1995-01))“; the GSM Standard 11.11, formally known as Specification of the Subscriber Identity Module—Mobile Equipment (Subscriber Identity Module—ME) interface (GSM 11.11 V5.3.0 (1996-07))”; MICHEAL ROBIN & MICHEL POULIN, DIGITAL TELEVISION FUNDAMENTALS (2000); JERRY WHITAKER AND BLAIR BENSON, VIDEO AND TELEVISION ENGINEERING (2003); JERRY WHITAKER, DTV HANDBOOK (2001); JERRY WHITAKER, DTV: THE REVOLUTION IN ELECTRONIC IMAGING (1998); and EDWARD M. SCHWALB, ITV HANDBOOK: TECHNOLOGIES AND STANDARDS (2004).

The commerce application 32 may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of lomega Corporation, 1821 W. Iomega Way, Roy, Ut. 84067, 801.332.1000, www.iomega.com). This computer-readable medium, or media, could be distributed to end-subscribers, licensees, and assignees. These types of computer-readable media, and other types not mention here but considered within the scope of the exemplary embodiments, allow the commerce application 32 to be easily disseminated. A computer program product comprises the commerce application 32 stored on the computer-readable medium. The commerce application 32 comprises computer-readable instructions/code for purchasing electronic products.

Exemplary embodiments may be physically embodied on or in any addressable (e.g., HTTP, I.E.E.E. 802.11, Wireless Application Protocol (WAP)) wireless device capable of presenting an IP address. Examples could include a computer, a wireless personal digital assistant (PDA), an Internet Protocol mobile phone, or a wireless pager.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method for purchasing products, comprising:
receiving a purchase request to purchase an electronic copy of a product, the purchase request comprising a product number that uniquely identifies the product and a device number that uniquely identifies a requesting device;
communicating the product number and the device number for registration;
receiving a verification message that the product number and the device number have been successfully registered; and
communicating the electronic copy of the product to the requesting device.

2. A method according to claim 1, further comprising the steps of i) receiving a product key that activates the electronic copy and ii) sending the product key to the requesting device.

3. A method according to claim 1, further comprising the steps of enabling queuing of the electronic copy for wireless transmission to the requesting device.

4. A method according to claim 1, further comprising the step of processing payment information for the electronic copy.

5. A method according to claim 1, wherein the step of receiving the purchase request comprises receiving at least one of a SKU, a bar code, and an RFID that uniquely identifies the product.

6. A method according to claim 1, further comprising the step of receiving a microprocessor number that uniquely identifies a microprocessor operating in the requesting device and that sends the purchase request.

7. A method according to claim 1, further comprising the step of receiving a wafer lot number and a microprocessor number, the wafer lot number identifying a wafer lot from which the microprocessor was manufactured, and the microprocessor number uniquely identifying a microprocessor manufactured from the wafer lot and operating in the requesting device that sends the purchase request.

8. A system, comprising:
a commerce application stored in memory; and
a processor communicating with the memory, the processor receives a purchase request to purchase an electronic copy of a product, the purchase request comprising a product number that uniquely identifies the product and a device number that uniquely identifies a requesting device,
the processor communicates the product number and the device number for registration and receives a verification message that the product number and the device number have been successfully registered, and
the processor communicates the electronic copy of the product to the requesting device.

9. A system according to claim 8, wherein the processor i) receives a product key that activates the electronic copy and ii) sends the product key to the requesting device.

10. A system according to claim 8, wherein the processor enables queuing of the electronic copy for wireless transmission to the requesting device.

11. A system according to claim 8, wherein the processor processes payment information for the electronic copy.

12. A system according to claim 8, wherein the processor receives at least one of a SKU, a bar code, and an RFID that uniquely identifies the product.

13. A system according to claim 8, wherein the processor receives a microprocessor number that uniquely identifies a microprocessor operating in the requesting device and that sends the purchase request.

14. A system according to claim 8, wherein the processor receives a wafer lot number and a microprocessor number, the wafer lot number identifying a wafer lot from which the microprocessor was manufactured, and the microprocessor number uniquely identifying a microprocessor manufactured from the wafer lot and operating in the requesting device that sends the purchase request.

15. A computer program product storing computer code for performing the steps:
receiving a purchase request to purchase an electronic copy of a product, the purchase request comprising a product number that uniquely identifies the product and a device number that uniquely identifies a requesting device;
communicating the product number and the device number for registration;
receiving a verification message that the product number and the device number have been successfully registered; and
communicating the electronic copy of the product to the requesting device.

16. A computer program product according to claim 15, further comprising computer code for i) receiving a product key that activates the electronic copy and ii) sending the product key to the requesting device.

17. A computer program product according to claim 15, further comprising computer code for enabling queuing of the electronic copy for wireless transmission to the requesting device.

18. A computer program product according to claim 15, further comprising computer code for processing payment information for the electronic copy.

19. A computer program product according to claim 15, further comprising computer code for receiving at least one of a SKU, a bar code, and an RFID that uniquely identifies the product.

20. A computer program product according to claim 15, further comprising computer code for receiving a wafer lot number and a microprocessor number, the wafer lot number identifying a wafer lot from which the microprocessor was manufactured, and the microprocessor number uniquely identifying a microprocessor manufactured from the wafer lot and operating in the requesting device that sends the purchase request.
